(19) United States
(12) Patent Application Publication
(10) Pub. No.: US 2015/0365730 A1
(43) Pub. Date: Dec. 17, 2015

(54) GENERATION AND USE OF USER BEHAVIORAL DATA FOR A PROGRAM

(71) Applicant: Verizon Patent and Licensing Inc., Arlington, VA (US)

(72) Inventors: Prabhu V. Mohan, Chennai (IN); Ramya Sundarraman, Chennai (IN); Sridevi Rajendran, Chennai (IN); Vinod Krishnan Surianarayanan, Chennai (IN); Anand Chandrasekar, Chennai (IN); Vijay A. Senthil, Chennai (IN); Raja Sundaram Ganesan, Chennai (IN); Parthasarathi Kathiresan, Chennai (IN); Vijayan Radhakrishnan, Chennai (IN)

(21) Appl. No.: 14/306,377

(22) Filed: Jun. 17, 2014

(51) Int. Cl. H04N 21/472; H04N 5/76; H04N 21/2387; H04N 21/6587; G11B 27/00; H04N 5/783; H04N 21/432; H04N 21/442

(52) U.S. Cl. CPC H04N 21/47217; H04N 21/432; H04N 5/7605; H04N 21/44222; H04N 21/6587; G11B 27/005; H04N 5/783; H04N 21/2387

(57) ABSTRACT

A method, a device, and a non-transitory storage medium to output a program during a program session; monitor trick play inputs during the outputting of the program; receive a trick play input during the outputting of the program; capture trick play data and time data based on a receipt of the trick play input; store the trick play data and the time data as behavioral data; and use the stored behavioral data to govern a subsequent outputting of the program during another program session.

### BACKGROUND

Currently, a user is able to enjoy viewing programs from many sources and delivery mechanisms (e.g., downloading, streaming, and recorded). For example, the user may enjoy streaming programs via a handheld device, a desktop computer, or a television.

### BRIEF DESCRIPTION OF THE DRAWINGS

FIG. 1A is a diagram illustrating an exemplary environment in which an exemplary embodiment of user behavioral playback may be implemented;

FIGS. 1B-1F are diagrams illustrating an exemplary embodiment of user behavioral playback processes;

FIG. 2 is a diagram illustrating an exemplary table that stores behavioral data;

FIG. 3 is a diagram illustrating another exemplary embodiment of a user behavioral playback process;

FIG. 4 is a diagram illustrating exemplary components of a device that may correspond to one or more devices in the environment depicted in FIG. 1A; and

FIGS. 5A and 5B are flow diagrams illustrating exemplary user behavioral playback processes.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

The term “program” as used herein, is intended to include visual data, audio data, or a combination of audio data and visual data. The program may originate from various sources, such as, for example, a television service, an Internet service, a digital video recording (DVR) service, data stored on a user device, a mobile service, etc. The program may be for example, television content, Internet content, user content, or other form of media. By way of further example, a program may be a movie, a television show, video-on-demand (VoD) content, live content, premium channel content, pay-per-view (PPV) content, music, a podcast, or other form of media (e.g., a slide show of pictures, etc.).

When a user digests (e.g., views and/or listens to) a program via a user device, the user may provide certain inputs during the course of experiencing the program. For example, the user may invoke what may be referred to as a ‘trick play” operation. The trick play operation may include fast-forwarding, rewinding, playing, stopping, pausing/resuming, advancing to a next item or place in time, returning to a previous item or place in time, instantly replaying (e.g., replay a segment of the program), repeating, etc. The fast-forward operation and the rewind operation may operate at different speeds (e.g., 1×, 2×, 3×, 4×, 8×, etc.) or as predefined time intervals, such as jumping forward 30 seconds or jumping backward 30 seconds. The user may invoke the trick play operation by pressing a trick play button of a remote control device, inputting a trick play command via a user interface or an input device (e.g., a keyboard, a mouse, etc.), uttering a voice command, etc.

The list of exemplary trick play operations is not intended to be exhaustive. Depending on the program (e.g., a movie, a song, etc.), a program player or other application involved in providing the program to the user, type of user device 120, etc., the trick play operation may include another type of input (e.g., zoom, etc.) and/or setting (e.g., audio setting (e.g., equalization, etc.), closed-caption, video setting, etc.) not specifically mentioned herein.

According to an exemplary embodiment, a user device captures behavioral data stemming from a user's behavior during the experiencing of a program. For example, the user device captures trick play inputs when the user is playing a movie. According to an exemplary embodiment, the user device stores the behavioral data. For example, in a scenario in which the program was downloaded and stored on the user device, the user device may store the behavioral data as metadata to the program file. According to other examples, the user device may store the behavioral data in a data structure or a database. The data structure or the database may be separate from the program file.

According to an exemplary embodiment, the user device uses the behavioral data as a basis for governing how playback of the program is to take place during a next time the user digests the program. For example, assume the user decides to play the same movie a month later, the user device uses the behavioral data stemming from the first time the user played the movie as a basis to govern how the movie is played for the user during the second time.

According to an exemplary embodiment, the user device includes an agent that provides the logic for user behavioral playback (i.e., capture, storage, and use of user behavioral data). The agent may operate at the application level. For example, the agent may be included in a program player or may be a stand-alone component of the user device. Alternatively, the agent may operate at a system level (e.g., operating system level).

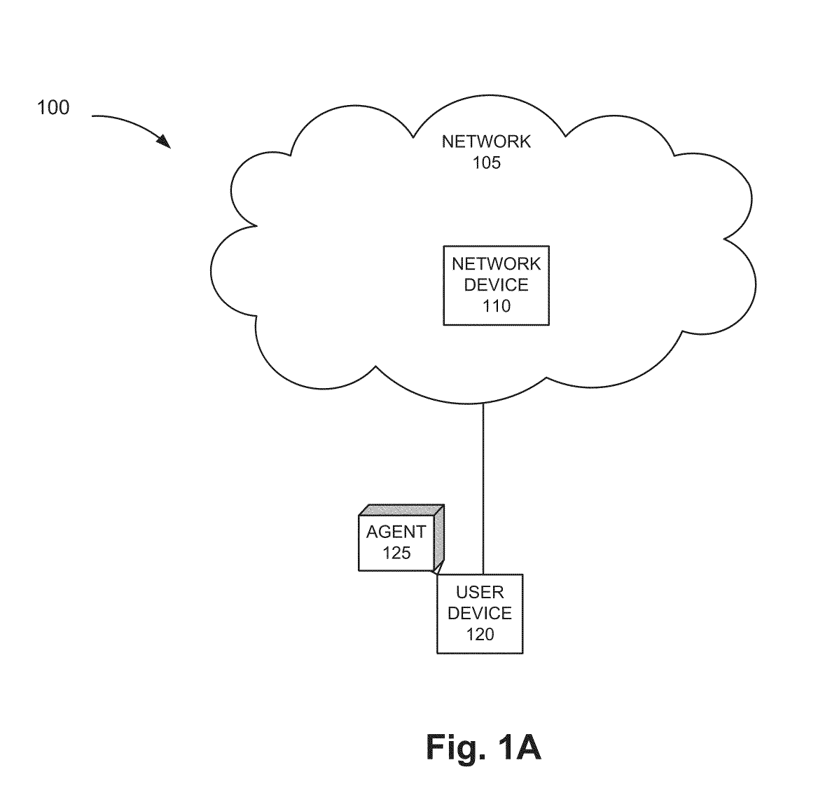

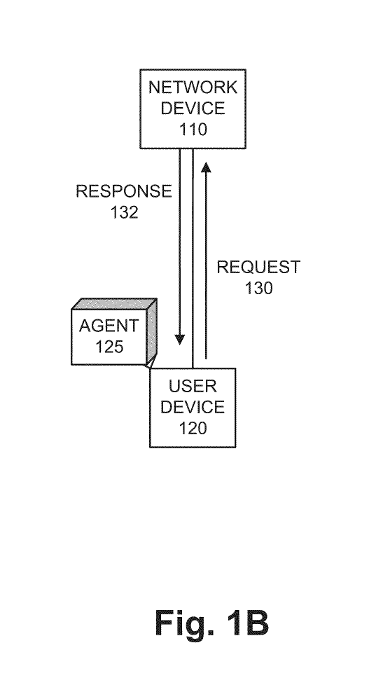

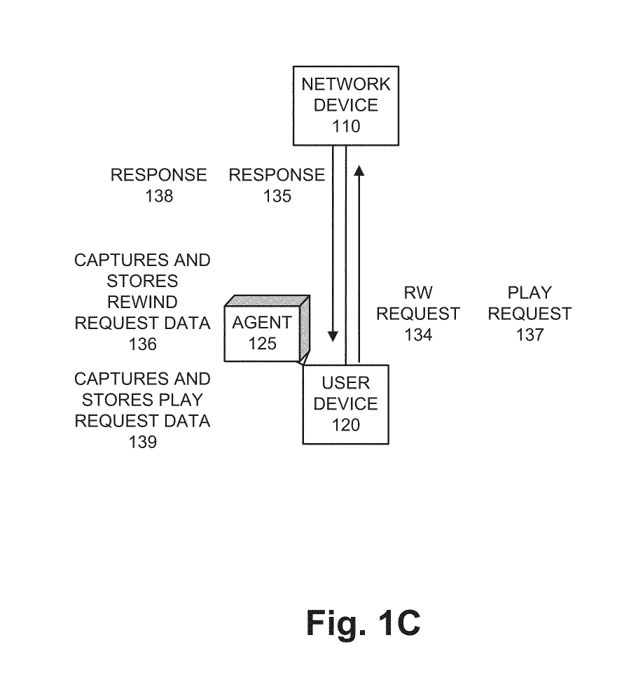

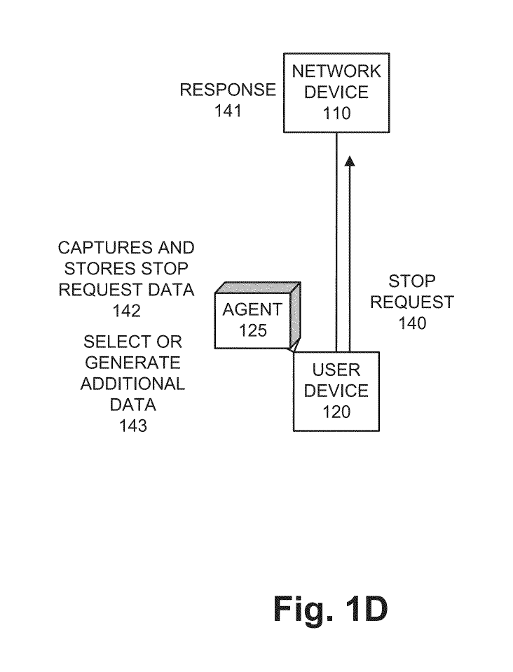

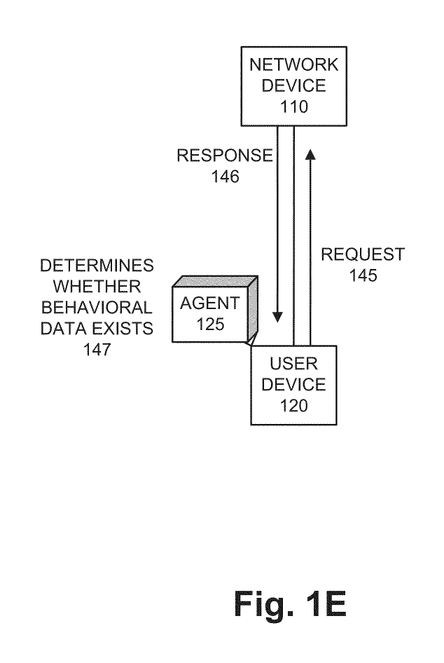

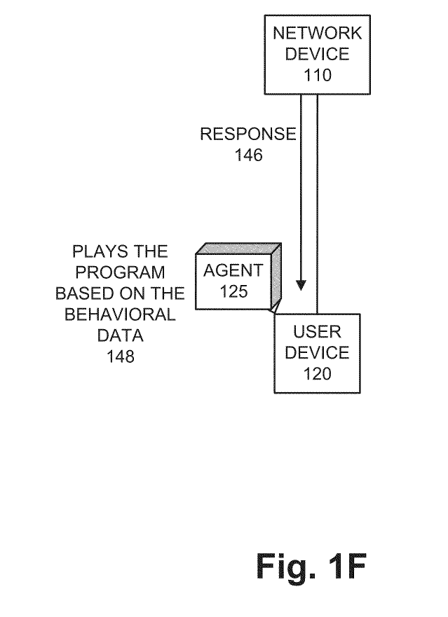

FIG. 1A is a diagram illustrating an exemplary environment 100 in which an exemplary embodiment of user behavioral playback may be implemented. As illustrated in FIG. 1A, exemplary environment 100 may include a network 105 that includes a network device 110 and a user device 120 that includes an agent 125.

The number of devices and configuration in environment 100 is exemplary and provided for simplicity. According to other embodiments, environment 100 may include additional devices, fewer devices, different devices, and/or differently arranged devices than those illustrated in FIG. 1A. For example, according to other embodiments, there may be multiple network devices 110. Additionally, or alternatively, according to other embodiments, environment 100 may not include network 105 and/or network device 110 (e.g., in a peer-to-peer architecture). Environment 100 may include wired (e.g., electrical, optical) and/or wireless connections between the devices illustrated.

Network 105 includes one or multiple networks of one or multiple types. For example, network 105 may include the Internet, a wide area network, a private network, a public network, an intranet, a local area network, a packet-switched network, a wired network (e.g., an optical network, a cable network, etc.), a wireless network (e.g., a mobile network, a cellular network, etc.), etc. Although not illustrated, network 105 may include various other network devices, such as, one or multiple security devices, routing devices, gateways, access points, etc.

Network device 110 includes a computing device that is capable of streaming and/or downloading a program to another device, such as user device 120. For example, network device 110 may correspond to a server device. The server device may take the form of a web server, an application server, a virtual server, an audio/video server, a file server, or some other type of network server.

User device 120 may correspond to various types of user devices. User device 120 may be a stationary device, a portable device, a handheld, a palmtop device, or a mobile device. For example, user device 120 may take the form of a computer (e.g., a desktop computer, a laptop computer, a palmtop computer, a tablet computer, a netbook, etc.), a personal digital assistant (PDA), a personal communication system (PCS) terminal, a smartphone, a Web or Internet access device, a set top box, or some other communication device (e.g., a vehicular infotainment system). User device 120 may include multiple devices (e.g., a set top box and a television, etc.). User device 120 may be able to record and playback programs.

Agent 125 includes the logic to provide user behavioral playback, as described herein. According to an exemplary implementation, agent 125 is implemented at an application layer. For example, agent 125 is included in a program player or is a stand-alone application. According to another exemplary implementation, agent 125 is implemented at a system level (e.g., operating system of user device 120). According to an exemplary implementation, behavioral data may be stored in a file (e.g., a registry file, a hidden data file, or some other type of system file depending on the platform in which user device 120 operates). The file may be loaded during boot-up of user device 120. For example, the file may be loaded during a Basic Input/Output System (BIOS) process or some other initialization process. The agent may include an application programming interface (API) to provide the control of an application (e.g., a program player, etc.) based on the behavioral data.

FIGS. 1B-1F are diagrams illustrating an exemplary user behavioral playback process. According to an exemplary scenario, and referring to FIG. 1B, a user (not illustrated) may wish to view a movie from a VoD television service. The user selects a movie to view via user device 120 (e.g., a set top box). In response, user device 120 transmits a request 130 to network device 110. Network device 110 receives request 130 and streams the selected movie in a response 132 to user device 120.

Referring to FIG. 1C, assume during the course of the movie, the user inputs a rewind request 134 via a remote control device (not illustrated). For example, the user wishes to replay a scene he or she liked. As illustrated, user device 120 transmits rewind request 134 to network device 110. In response to receiving rewind request 134, network device 110 provides a response 135. Additionally, as illustrated, agent 125 captures and stores rewind request data 136 stemming from rewind request 134. For example, the rewind request data 136 may include a timestamp (e.g., based on time counter information) and a rewind command code. Subsequently, during the rewinding of the movie, the user inputs a play request 137 via the remote control device. User device 120 transmits play request 137 to network device 110. In response to receiving play request 137, network device provide a response 138. Additionally, as illustrated, agent 125 captures and stores play request data 139. For example, play request data 139 may include a timestamp and a play command code.

Referring to FIG. 1D, thereafter, the user watches the remaining portion of the movie until the end. When the ending credits begin to appear, the user inputs a stop request 140 via the remote control device. As illustrated, user device 120 transmits stop request 140 to network device 110. In response to receiving stop request 134, network device 110 stops streaming the movie (i.e., response 141). Additionally, as illustrated, agent 125 captures and stores stop request data 142. According to this example, agent 125 may store the rewind request data, the play request data, and the stop request data in a file (i.e., behavioral data).

As described further below, agent 125 may also select from existing data (e.g., metadata associated with the movie) or generate data 143 that does not necessarily stem from rewind request 134 and play request 137, such as name of the movie, date and time the user is watching the movie, an identifier that identifies the user, etc. Agent 125 may use this additional data when, for example, selecting and using the behavioral data on behalf of the user for a future viewing session of the movie. The additional data may be also stored as behavioral data.

Referring to FIG. 1E, assume a few weeks later the user decides to view the same movie later because the user was somewhat distracted during the previous session. The user selects the movie to view via user device 120 (e.g., a set top box). In response, user device 120 transmits a request 145 to network device 110. Network device 110 receives request 145 and streams the selected movie in a response 146 to user device 120.

As further illustrated, agent 125 determines whether behavioral data exists for the program. For example, agent 125 identifies the name of the program (e.g., the name of the movie), and uses this data as a key to determine whether behavioral data exists (e.g., is stored) for the program. Agent 125 may use other data to determine whether behavioral data exists. For example, agent 125 identifies the user of user device 120 and determines whether behavioral data exists for this user and this program. According this example, agent 125 determines that there is behavioral data for the selected movie and for this user. Referring to FIG. 1F, based on the stored behavioral data, the movie is played to the user based on the behavioral data.

The scenarios described in reference to FIGS. 1B-1F are exemplary. Various modifications to the user behavioral playback and described in relation to FIGS. 1B-1F may be implemented. For example, according to an exemplary embodiment, agent 125 may determine the age of the behavioral data. Based on the age of the behavioral data, agent 125 determines whether to use the behavioral data. For example, agent 125 may use a threshold time value. By way of example, if the user's last viewing session was over one year ago, agent 125 may determine to not use the behavioral data.

According to an exemplary embodiment, agent 125 provides a user interface that allows the user to turn on and turn off (i.e., enable and disable) agent 125. Additionally, according to an exemplary embodiment, agent 125 provides other user interfaces that allow the user to set various control mechanisms. For example, agent 125 may provide a user interface that allows a user to be prompted whether behavioral data is to be used. As an example, upon commencement of a session, agent 125 determines that behavioral data exists. Subsequently, agent 125 prompts the user to confirm that user behavioral playback is desired.

According to an exemplary embodiment, agent 125 allows the user to override the user behavioral playback. For example, assume a program is being presented to the user in accordance with the behavioral data. During this time, the user wishes to skip a scene even though the behavioral data does not indicate to do so. The user may skip the scene. In this case, according to an exemplary embodiment, agent 125 adds this new input data to the behavioral data. Alternatively, agent 125 creates a new file for the behavioral data. That is, agent 125 may store different versions of the behavioral data. Agent 125 may provide a user interface to allow the user to name a version. For example, the user may store one version that highlights all the action sequences in the movie (e.g., for the user) and another version that provides a shortened or summary version of the movie (e.g., when viewing the movie with a friend, etc.). When multiple versions exist for the same program, agent 125 may prompt the user to select the correct version to use for user behavioral playback.

Agent 125 may also provide other functions. For example, assume that user device 120 establishes a program streaming session and behavioral data is to be used. Agent 125 may inspect the behavioral data to determine the type of trick play inputs. As an example, assume that agent 125 determines that a fast-forward input is coming up based on an inspection of the behavioral data. Agent 125 may pass this information, issue a request, and/or pass a value to the appropriate component (e.g., a program player or streaming logic), in an attempt to regulate the amount of program data stored in the buffer. In this way, agent 125 may improve the user's experience when viewing the program by minimizing potential latency caused by the fast-forwarding and the available program data in the buffer. Thus, for example, the streaming algorithm logic may increase the buffer level to the maximum in response to receiving the request from agent 125. Indeed, since the playback signature of the program is known based on the behavioral data, absent receiving any overriding inputs from the user, agent 125 may treat the behavioral data as predictive data and use this data to govern the program streaming session.

While the above scenario provides an example of the predictive playback function of agent 125, the program player or streaming logic may consider data, other than data or requests from agent 125, to govern buffer levels. For example, the program player or streaming logic may consider connection states and metrics (e.g., received signal strength during the program session, available bandwidth, etc.). Additionally, although the above example is illustrative for adjusting a buffer level based on the behavioral data, during an adaptive programming session, parameters other than or in addition to buffer levels may be influenced based on the predictive playback function of agent 125 such as selection of program segment bit-rates, when requests to refill the buffer are made, etc.

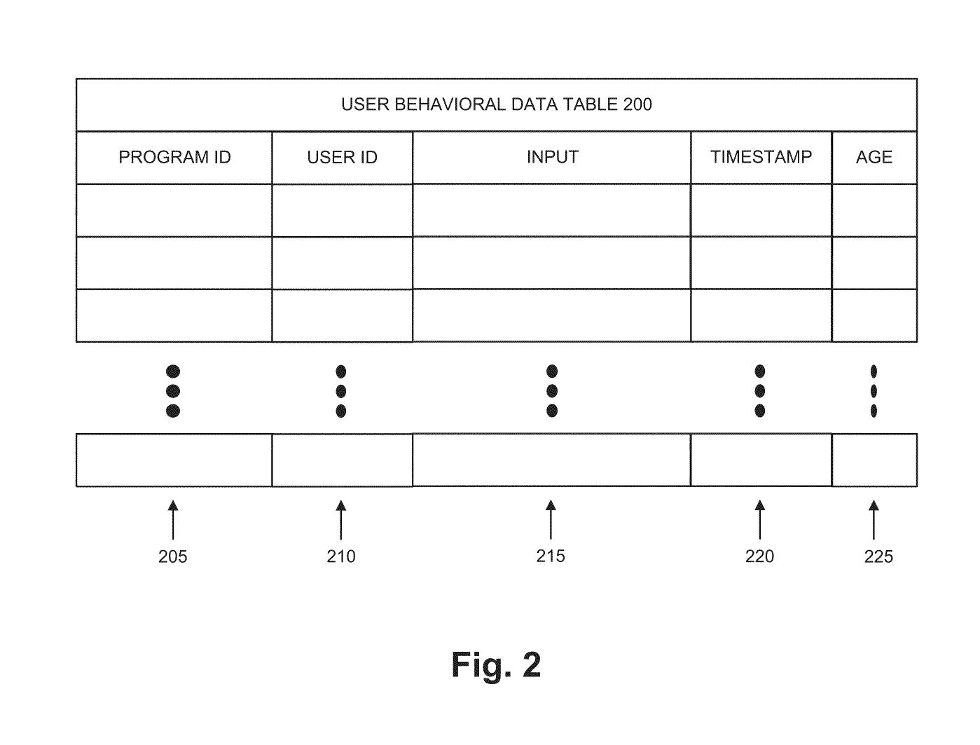

FIG. 2 is a diagram illustrating an exemplary user behavioral data table 200 that stores exemplary behavioral data. As illustrated, table 200 includes a program identifier field 205, a user identifier field 210, an input field 215, a timestamp field 220, and an age field 225.

Program identifier field 205 stores data that identifies a program. For example, the data may indicate a title of the program, a file name, a user-created string, or other suitable form of a program identifier. User identifier field 210 stores data that identifies the user. For example, the data may indicate the user's name, a user-created string, or some other suitable form of a user identifier.

Input field 215 stores data that identifies a trick play operation. For example, the data may indicate a fast-forward, a rewind, a stop, a pause, a resume, etc., as previously described.

Timestamp field 220 stores data that indicates a time pertaining to the trick play operation. Depending on the type of program, the time may be a time code (e.g., hours, minutes, seconds; hours, minutes, seconds, frames, etc.). For example, when the program is an episode of a television series, a movie, or music (e.g., a song), the time code that indicates a progress point of the program. According to other examples, the time may be another type of referent. For example, assume the program is a slide show of pictures in which the user selects next or previous inputs to control the flow of the presentation of pictures. The time may indicate a real-time value within a real-time time window corresponding to the start of the slide show to the end of the slide show. For example, the user may select a next button at irregular times to view pictures. Each next button would be assigned a timestamp that is relative to the start of the slide show.

Age field 225 stores data that indicates the age of the program session. For example, the data may indicate a date and timestamp, a string that indicates a time period (e.g., months or months and days, etc.), or some other suitable form of time-based indicator.

According to other implementations, table 200 may include additional fields, fewer fields, and/or different fields than those illustrated in FIG. 2 and described herein. For example, as previously described, the behavioral data may include settings or user preferences data (e.g., audio setting, closed-caption, video setting, size of program player window (e.g., full-screen, resized, etc.), location of program player on a display, etc.

As previously described, according to an exemplary embodiment, user device 120 may store the program. For example, user device 120 may download the program from another device. In a manner similar to that previously described, agent 125 monitors trick play operations during the digestion of the program and store behavioral data resulting from the monitoring. Additionally, agent 125 may store additional data (e.g., setting data, etc.) as behavioral data. Since the program is stored (e.g., on user device 120), agent 125 may store the behavioral data as metadata for the program.

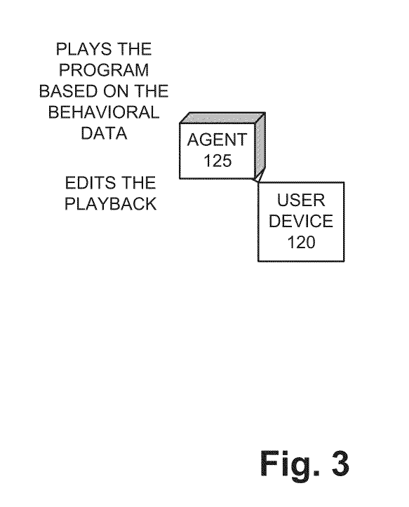

Subsequently, in a manner similar to that previously described in relation to FIG. 1E, when the user wishes to play the program again (e.g., a week later, etc.), agent 125 determines whether behavioral data (e.g., stored in table 200), which pertains to the program, exists. Further, in a manner similar to that previously described in relation to FIG. 1F, agent 125 plays the program based on the behavioral data. According to an exemplary embodiment, agent 125 edits or modifies the playback of the program. Referring to FIG. 3, assume the user is watching a movie and agent 125 is governing the playback of the movie based on the behavioral data. Also, assume that the behavioral data includes a pause that lasts five minutes at a particular time during the movie. In this example, agent 125 ignores the pause or shortens the pause (e.g., to one or two minutes). In this regard, agent 125 applies a heuristic that a long pause may stem from a circumstance during the original session (e.g., when the behavioral data is generated and stored) that is unlikely to be present in a subsequent session. In the event that the user inputs a pause (e.g., an over-riding input) when agent 125 ignores the pause or shortens the pause, agent 125 may generate data to indicate a confirmation that the user wishes the long pause to be carried out during playback.

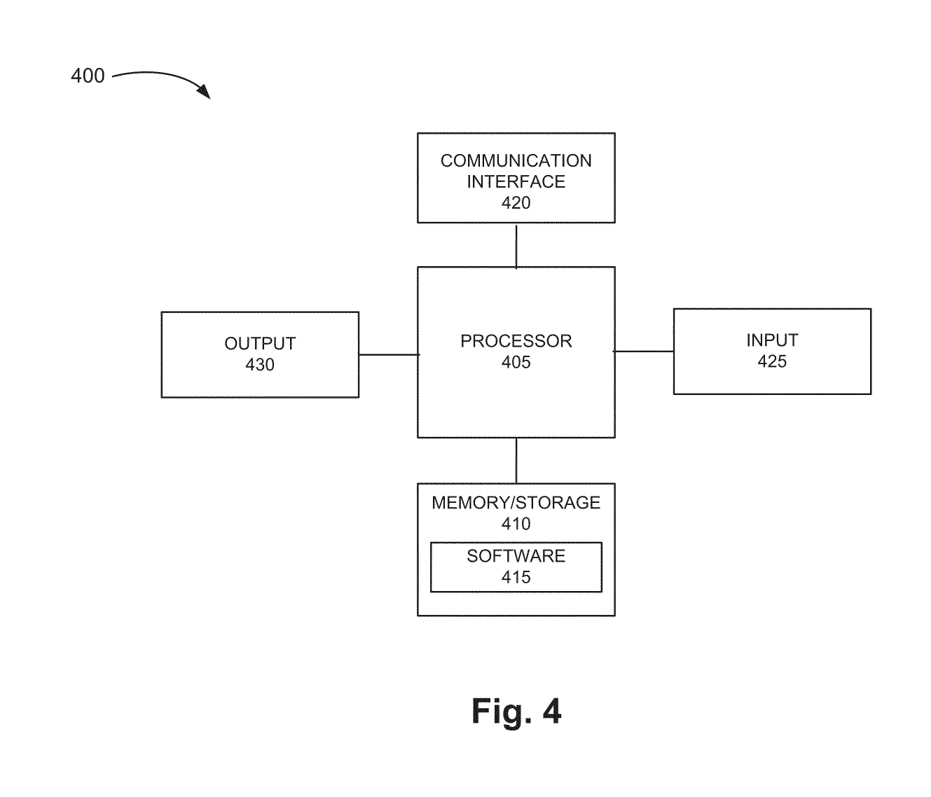

FIG. 4 is a diagram illustrating exemplary components of a device 400 that may correspond to one or more of the devices in environment 100. For example, device 400 may correspond to components included in user device 120. As illustrated, device 400 includes a processor 405, a memory/storage 410 that stores software 415, a communication interface 420, an input 425, and an output 430. According to other implementations, device 400 may include fewer components, additional components, different components, and/or a different arrangement of components than those illustrated in FIG. 4 and described herein.

Processor 405 includes one or multiple processors, microprocessors, data processors, co-processors, multi-core processors, application specific integrated circuits (ASICs), controllers, programmable logic devices, chipsets, field programmable gate arrays (FPGAs), system on chips (SoCs), programmable logic devices (PLSs), microcontrollers, application specific instruction-set processors (ASIPs), central processing units (CPUs), or some other component that interprets and/or executes instructions and/or data. Processor 405 may be implemented as hardware (e.g., a microprocessor, etc.) or a combination of hardware and software (e.g., a SoC, an ASIC, etc.). Processor 405 may include one or multiple memories (e.g., memory/storage 410), etc.

Processor 405 may control the overall operation, or a portion of operation(s) performed by device 400. Processor 405 may perform one or multiple operations based on an operating system and/or various applications or programs (e.g., software 415). Processor 405 may access instructions from memory/storage 410, from other components of device 400, and/or from a source external to device 400 (e.g., another device, a network, etc.).

Memory/storage 410 includes one or multiple memories and/or one or multiple other types of storage mediums. For example, memory/storage 410 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 410 may include a hard disk (e.g., a magnetic disk, an optical disk, a magneto-optic disk, a solid state disk, etc.) and a corresponding drive. Memory/storage 410 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 410 may include drives for reading from and writing to the storage medium.

Memory/storage 410 may be external to and/or removable from device 400, such as, for example, a Universal Serial Bus (USB) memory stick, a dongle, a hard disk, mass storage, off-line storage, or some other type of storage medium (e.g., a compact disk (CD), a digital versatile disk (DVD), a Blu-Ray® disk (BD), etc.). Memory/storage 410 may store data, software, and/or instructions related to the operation of device 400

Software 415 includes an application or a program that provides a function and/or a process. In this context, the term “program” is used in the sense of a sequence of instructions designed for execution on a computer system. A “program” or a “computer program” may include a subroutine, a function, a procedure, an object method, an object implementation, an applet, a servlet, a source code, an object code, a shared library/dynamic load library and/or other sequence of instructions designed for execution on a computer system. The term “program,” when used to mean, for example, audio and/or video data versus used to mean a set of instructions will be apparent from the context of use in the present document.

Software 415 may include firmware. For example, with reference to user device 120, software 415 may include an application that, when executed by processor 405, provides the functions of agent 125, as described herein.

Communication interface 420 permits device 400 to communicate with other devices, networks, systems and/or the like. Communication interface 420 includes one or multiple wireless interface(s) and/or wired interface(s). For example, communication interface 420 may include one or multiple transmitter(s) and receiver(s), or transceiver(s).

Input 425 provides an input into device 400. For example, input 425 may include a keyboard, a keypad, a touchscreen, a touch pad, a touchless screen, a mouse, an input port, a button, a switch, a microphone, a knob, and/or some other type of input.

Output 430 provides an output from device 400. For example, output 430 may include a display, a speaker, a light (e.g., light emitting diode(s), etc.), an output port, a vibratory mechanism, and/or some other type of output.

Device 400 may perform a function or a process in response to processor 405 executing software instructions stored by memory/storage 410. For example, the software instructions may be read into memory/storage 410 from another memory/storage 410 or read from another device via communication interface 420. The software instructions stored in memory/storage 410 may cause processor 405 to perform processes described herein. Alternatively, according to another implementation, device 400 may perform a process or a function based on the execution of hardware (e.g., processor 405, etc.).

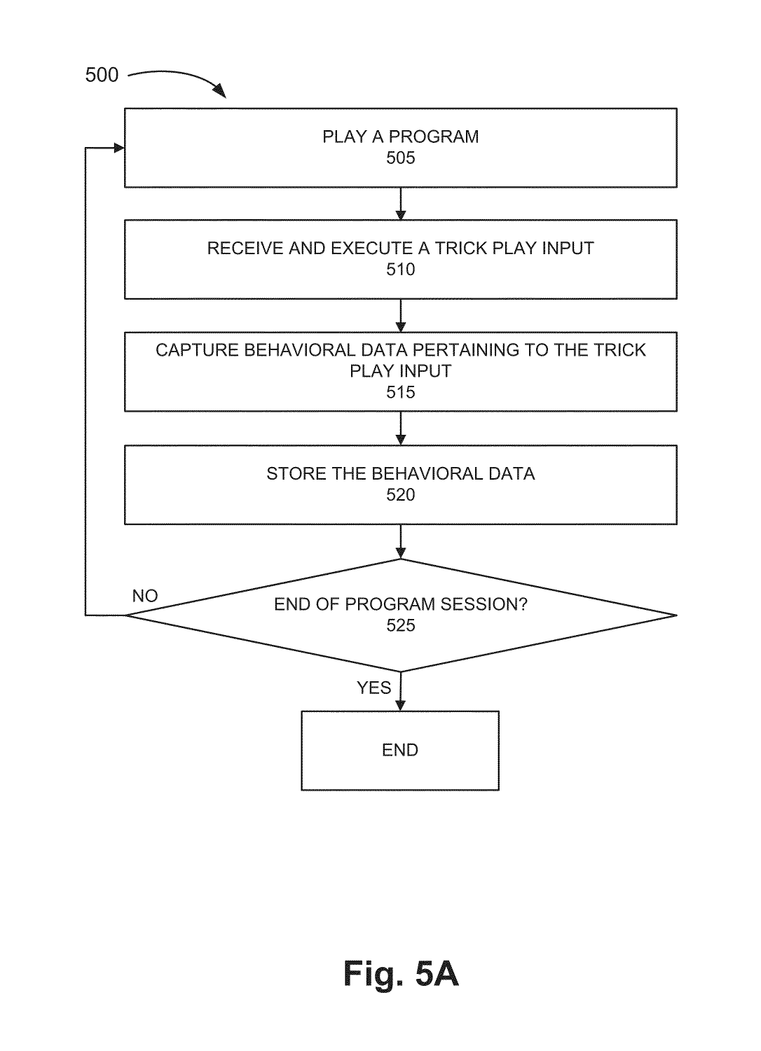

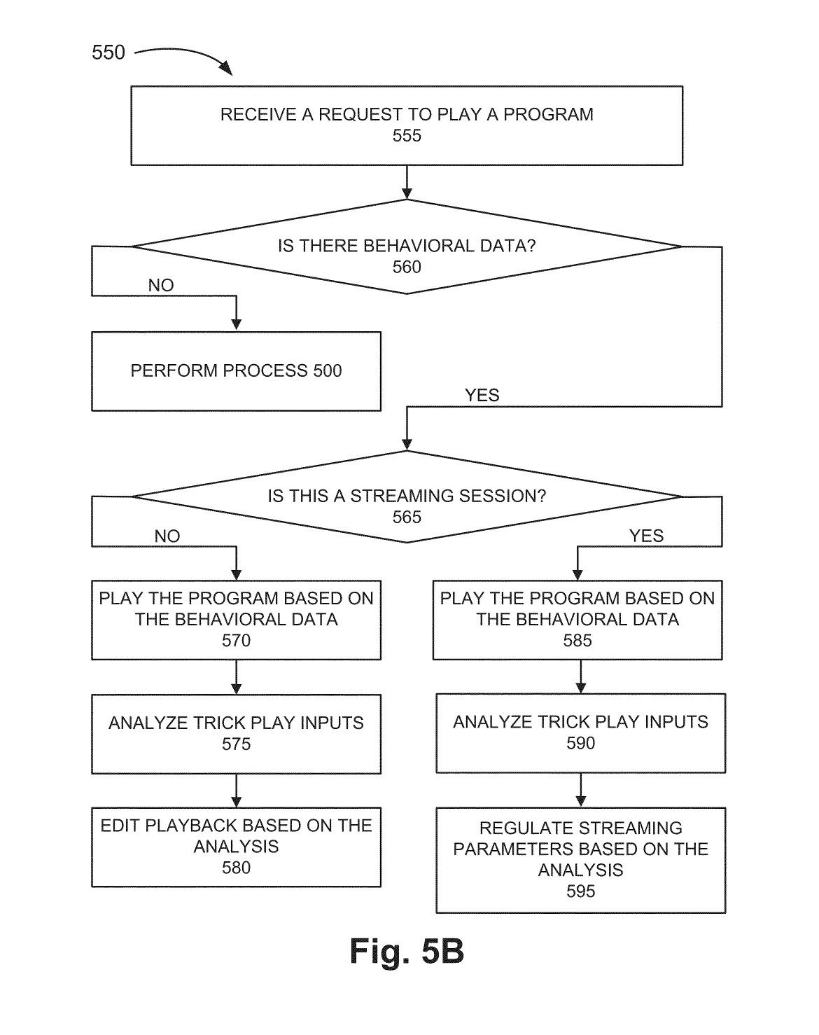

FIG. 5A is a flow diagram illustrating an exemplary user behavioral playback process 500. Process 500 is directed to the embodiment, previously described above with respect to FIGS. 1A-1D, as well as elsewhere in this description, in which agent 125 continuously monitors trick play operations during the digestion of a program by the user and generates behavioral data. According to an exemplary embodiment, one or more operations of process 500 are performed by agent 125. For example, the functionality of agent 125 may be implemented by processor 405 executing software 415.

Referring to FIG. 5A, in block 505, a program is played. For example, user device 120 plays a program in response to receiving a request from a user of user device 120. Additionally, for example, when user device 120 is shared among multiple users, agent 125 may prompt a user for his or her identity.

In block 510, a trick play input is received and executed. For example, the user of user device 120 inputs a trick play input during the viewing and/or listening of the program. The trick play input may be a fast-forward request, a rewind request, a pause request, or some other type of input to cause the program to fast-forward, rewind, pause, or perform some other operation.

In block 515, behavioral data pertaining to the trick play input is captured. For example, agent 125 of user device 120 captures behavioral data pertaining to the trick play input. For example, as previously described, the behavioral data may include input data (e.g., a command code, etc.) and time information. As previously described, agent 125 may select, obtain, or generate additional data (e.g., title of program, date and time of session, user identifier, etc.).

In block 520, the behavioral data is stored. For example, agent 125 stores the behavioral data. The behavioral data may be stored as a part of the program file or separate from the program file. For example, the behavioral data may be stored as metadata to the program file or in a data structure or a database, such as table 200.

In block 525, it is determined whether the program session has ended. For example, agent 125 determines whether the program session has ended or agent 125 is informed that the program session is ended. By way of example, the user may close a program player, a tear down of a connection may take place, etc., which in effect constitutes the end of a program session. If it is determined that the program session has not ended (block 525—NO), then the process 500 continues to block 505. If it is determined that the program session has ended (block 525—YES), then process 500 ends.

Although FIG. 5A illustrates an exemplary process 500, according to other implementations, process 500 may include additional operations, fewer operations, and/or different operations than those illustrated in FIG. 5A, and described herein.

FIG. 5B is a flow diagram illustrating an exemplary user behavioral playback process 550. Process 550 is directed to the embodiment, previously described above with respect to FIGS. 1E and 1F, as well as elsewhere in this description, in which agent 125 uses behavioral data as a basis to govern the playback of a program. According to an exemplary embodiment, one or more operations of process 550 are performed by agent 125. For example, the functionality of agent 125 may be implemented by processor 405 executing software 415.

Referring to FIG. 5B, in block 555, a request to play a program is received. For example, a user inputs a request via user device 120 to play a program.

In block 560, it is determined whether there is behavioral data. For example, agent 125 determines whether there is behavioral data for the program. For example, as previously described, agent 125 may use a program identifier as a key to search a data structure or a database (e.g., table 200) to determine whether there is behavioral data. Alternatively, when the behavioral data is stored as metadata, agent 125 may determine whether there is behavioral data from a program file (e.g., that includes the program and the metadata).

If it is determined that there is no behavioral data (block 560—NO), then process 500 is performed. For example, agent 125 performs process 500, as described in relation to FIG. 5A.

If it is determined that there is behavioral data (block 560—YES), it is determined whether this is a streaming session (block 565). For example, agent 125 determines whether the program session is an adaptive streaming session. Alternatively, agent 125 is informed (e.g., by another component of user device 120) of the type of program session. As previously described, the program may be stored on user device 120 or the program may be streamed (e.g., adaptively streamed) from another device (e.g., network device 110).

If it is determined that the program session is not a streaming session (block 565—NO), then the program is played based on the behavioral data (block 570). For example, agent 125 governs the playback of the program based on the behavioral data. As previously described, according to an exemplary embodiment, agent 125 may perform other operations during playback. These operations are optional and described in relation to blocks 575 and 580.

In block 575, trick play inputs are analyzed. For example, agent 125 analyzes the trick play inputs included in the behavioral data based on policies or heuristics. For example, agent 125 may identify the presence of a long pause or a long period of fast-forward. As previously described, in one example, agent 125 analyzes the long pause and concludes that the long pause should be shortened or omitted. According to another example, agent 125 may identify a long period of fast-forward and conclude that a skip input (when available) may be more efficient to reach the endpoint of the fast-forward versus a long period of fast-forward.

In block 580, playback is edited based on the analysis. For example, agent 125 edits the behavioral data and/or modifies the playback of the program based on the analysis. For example, as previously described, agent 125 may ignore or shorten the pause, or invoke a skip input and shorter period of fast-forward to reach the endpoint of the fast-forward.

If it is determined that the program session is a streaming session (block 565—YES), then the program is played based on the behavioral data (block 585). This step is the same as that described in relation to block 570. As previously described, according to an exemplary embodiment, agent 125 may perform other operations during a program streaming session. These operations are optional and described in relation to blocks 590 and 595.

In block 590, trick play inputs are analyzed. For example, agent 125 analyzes up-coming trick play inputs. Agent 125 may apply rules that identify trick play inputs that may disrupt the user's experience. For example, as previously described, a fast-forward input of a particular duration may cause a latency problem in view of the current buffer level.

In block 595, streaming parameters are regulated based on the analysis. For example, agent 125 may pass information or issue a request to the appropriate streaming component to regulate a parameter associated with the streaming session. As an example, agent 125 may pass a value or issue a request to increase the buffer level to the maximum based on the analysis of the fast-forward input.

Although FIG. 5B illustrates an exemplary process 550, according to other implementations, process 550 may include additional operations, fewer operations, and/or different operations than those illustrated in FIG. 5B, and described herein. For example, blocks 575 and 580 may also be performed when the program session is a streaming session.

The foregoing description of implementations provides illustration, but is not intended to be exhaustive or to limit the implementations to the precise form disclosed. Accordingly, modifications to the implementations described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while series of blocks are described with regard to the processes illustrated in FIGS. 5A and 5B, the order of the blocks may be modified in other implementations. Further, non-dependent blocks may be performed in parallel. Additionally, with respect to other processes described in this description, the order of operations may be different according to other implementations, and/or operations may be performed in parallel.

The embodiments described herein may be implemented in many different forms of software and/or firmware executed by hardware. For example, a process or a function may be implemented as “logic” or as a “component.” The logic or the component may include, for example, hardware (e.g., processor 405, etc.), or a combination of hardware and software (e.g., software 415). The embodiments have been described without reference to the specific software code since software can be designed to implement the embodiments based on the description herein.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

Additionally, embodiments described herein may be implemented as a non-transitory storage medium that stores data and/or information, such as instructions, program code, data structures, program modules, an application, etc. The program code, instructions, application, etc., is readable and executable by a processor (e.g., processor 405) of a computational device. A non-transitory storage medium includes one or more of the storage mediums described in relation to memory/storage 410.

No element, act, operation, or instruction described in the present application should be construed as critical or essential to the embodiments described herein unless explicitly described as such.

What is claimed is:

1. A method comprising:
playing, by a user device, a program;
monitoring, by the user device, trick play inputs during the playing of the program;
receiving, by the user device, a trick play input during the playing of the program;
capturing, by the user device, trick play data and time data based on the monitoring and the receiving;
storing, by the user device, the trick play data and the time data as behavioral data; and
using, by the user device, a stored behavioral data to govern a subsequent playing of the program.

2. The method of claim 1, wherein the using further comprises:
receiving, by the user device, a request to play the program again;
determining whether behavioral data has been previously stored for the program based on receiving the request; and
using the stored behavioral data to govern playing the program again based on determining that behavioral data has been previously stored.

3. The method of claim 2, further comprising:
determining, by the user device, whether the program is to be played again via an adaptive streaming session; and
using the behavioral data as a basis to regulate a parameter of the adaptive streaming session based on determining that the program is to be played again via the adaptive streaming session, wherein the parameter includes at least one of a buffer level or a program segment bit-rate.

4. The method of claim 1, wherein the program corresponds to a movie.

5. The method of claim 1, further comprising:
determining, by the user device, an age of the stored behavioral data;
comparing, by the user device, the age of the stored behavioral data to a threshold value; and
determining, by the user device, whether to use the stored behavioral data based on the comparing.

6. The method of claim 1, further comprising:
identifying, by the user device, a user of the user device; and
storing, by the user device, a user identifier as the behavioral data.

7. The method of claim 1, wherein the trick play inputs include fast-forward, rewind, stop, pause, resume, play, and repeat.

8. A device comprising:
a communication interface;
a memory, wherein the memory stores instructions; and
a processor, wherein the processor executes the instructions to:
play a program;
monitor trick play inputs during the playing of the program;
receive a trick play input during the playing of the program;
capture trick play data and time data based on a receipt of the trick play input;
store the trick play data and the time data as behavioral data; and
use a stored behavioral data to govern a subsequent playing of the program.

9. The device of claim 8, wherein processor further executes the instructions to:
receive a request to play the program again from a user of the device;
determine whether behavioral data exists for the program based on the request; and
play the program again using the stored behavioral data based on a determination that behavioral data exists.

10. The device of claim 9, wherein the processor further executes the instructions to:
determine whether the program is to be played again via an adaptive streaming session; and
use the behavioral data as a basis to regulate a parameter of the adaptive streaming session based on a determination that the program is to be played again via the adaptive streaming session, wherein the parameter includes at least one of a buffer level or a program segment bit-rate.

11. The device of claim 9, wherein when playing the program again, the processor further executes the instructions to:
analyze trick play data included in the stored behavioral data during a playing of the program again;
determine whether a trick play input indicated by the trick play data should be edited based on an analysis of the trick play data; and
modify the trick play input based on a determination that the trick play input should be edited.

12. The device of claim 9, wherein when playing the program again, the processor further executes the instructions to:
receive a trick play input;
execute the trick play input; and
add new behavioral data to the stored behavioral data.

13. The device of claim 9, wherein the processor further executes the instructions to:
determine that there are multiple versions of the stored behavioral data;
provide a user interface that allows the user to select one of the multiple versions of the stored behavioral data;
receive, via the user interface, a selection of the one of the multiple versions of the stored behavioral data; and
use the one of the multiple versions of the stored behavioral data when playing the program again.

14. The device of claim 8, wherein the processor further executes the instructions to:
identify a user of the device;
store a user identifier that identifies the user as the behavioral data; and when receiving a request to play the program again, the processor further executes the instructions to:
use the user identifier to select the stored behavioral data.

15. The device of claim 8, wherein the processor further executes the instructions to:
determine an age of the stored behavioral data;
compare the age of the stored behavioral data to a threshold value; and
determine whether to use the stored behavioral data based on a comparison between the age of the stored behavioral data and the threshold value.

16. A non-transitory storage medium comprising instructions executable by a processor of a computational device, which when executed by the processor, cause the computational device to:
output a program during a program session;
monitor trick play inputs during the outputting of the program;
receive a trick play input during the outputting of the program;
capture trick play data and time data based on a receipt of the trick play input;
store the trick play data and the time data as behavioral data; and
use a stored behavioral data to govern a subsequent outputting of the program during another program session.

17. The non-transitory storage medium of claim 16, further comprising instructions, which when executed by the processor, cause the computational device to:
receive a request to output the program again from a user of the computational device;
determine whether behavioral data has been previously stored for the program based on the request; and
play the program again using the stored behavioral data based on a determination that behavioral data has been previously stored for the program.

18. The non-transitory storage medium of claim 17, further comprising instructions, which when executed by the processor, cause the computational device to:
analyze trick play data included in the stored behavioral data during an outputting of the program again;
determine whether a trick play input indicated by the trick play data should be edited based on an analysis of the trick play data; and
modify the trick play input based on a determination that the trick play input should be edited.

19. The non-transitory storage medium of claim 17, further comprising instructions, which when executed by the processor, cause the computational device to:
receive a trick play input during the other program session;
execute the trick play input; and
add new behavioral data to the stored behavioral data.

20. The non-transitory storage medium of claim 16, further comprising instructions, which when executed by the processor, cause the computational device to:
determine an age of the stored behavioral data;
compare the age of the stored behavioral data to a threshold value; and
determine whether to use the stored behavioral data based on a comparison between the age of the stored behavioral data and the threshold value.
